(19) United States
(12) Patent Application Publication
(10) Pub. No.: US 2023/0352647 A1
(43) Pub. Date: Nov. 2, 2023

(54) ELECTRODE LAMINATE MANUFACTURING METHOD, ALL-SOLID-STATE BATTERY MANUFACTURING METHOD, ELECTRODE LAMINATE, AND ALL-SOLID-STATE BATTERY

(71) Applicants: TOYOTA JIDOSHA KABUSHIKI KAISHA, Toyota-shi (JP); Panasonic Holdings Corporation, Osaka (JP)

(72) Inventors: Sachie AKIBA, Toyota-shi (JP); Kazuya OTSU, Miyoshi-shi, Aichi-ken (JP); Yasutaka TSUTSUI, Osaka (JP); Tsutomu KOSHIZUKA, Osaka (JP)

(73) Assignees: TOYOTA JIDOSHA KABUSHIKI KAISHA, Toyota-shi (JP); Panasonic Holdings Corporation, Osaka (JP)

(21) Appl. No.: 18/139,571

(22) Filed: Apr. 26, 2023

(30) Foreign Application Priority Data
May 2, 2022 (JP) 2022-075975

(51) Int. Cl. H01M 4/04; H01M 10/0562; H01M 4/485

(52) U.S. Cl. CPC H01M 4/0435; H01M 10/0562; H01M 4/485; H01M 2300/0068

(57) ABSTRACT

A first layer is formed. A second layer is formed by coating a slurry onto a surface of the first layer. The second layer is subjected to pressing, thereby manufacturing an electrode laminate. The forming of the first layer is performed such that a relation of an Expression “0.1<Sa<0.2” is satisfied. In the Expression, Sa (μm) represents an arithmetic mean height of the surface of the first layer.

### CROSS-REFERENCE TO RELATED APPLICATION

This application claims priority to Japanese Patent Application No. 2022-075975 filed on May 2, 2022, incorporated herein by reference in its entirety.

### BACKGROUND

### 1. Technical Field

The present disclosure relates to an electrode laminate manufacturing method, an all-solid-state battery manufacturing method, an electrode laminate, and an all-solid-state battery.

### 2. Description of Related Art

Japanese Unexamined Patent Application Publication No. 2017-062938 (JP 2017-062938) discloses a solid electrolyte layer formed by coating a slurry on an active material layer having a surface roughness Ra of 0.29 μm to 0.98 μm.

### SUMMARY

For example, in a manufacturing process of an all-solid-state battery, an electrode laminate may be formed by repeated coating of a slurry. The electrode laminate is subjected to pressing. When interlayer adhesion strength is low, interlayer delamination may occur during the pressing.

Conventionally, an anchor effect is used to avert interlayer delamination. That is to say, surface roughness of a base layer (first layer) is increased. Part of the slurry penetrates into voids at a surface of the first layer. An upper layer (second layer) is formed by solidification of the slurry. Anchor portions are formed by solidification of the slurry that has penetrated the voids at the surface of the first layer. Improved interlayer adhesion strength between the first layer and the second layer due to formation of the anchor portions is anticipated.

However, it has newly been found that bubbles are generated in the second layer due to the increase in the surface roughness of the first layer. There is a possibility that bubbles will degrade battery performance.

An object of the present disclosure is to reduce bubbles while increasing interlayer adhesion strength.

Hereinafter, technical configurations and functions and effects of the present disclosure will be described. Note however, that an acting mechanism according to the present specification includes estimation. The acting mechanism does not limit the technical scope of the present disclosure.

1. An electrode laminate manufacturing method includes the following (a) to (c).
(a) Forming a first layer.
(b) Forming a second layer by coating a slurry onto a surface of the first layer.
(c) Subjecting the second layer to pressing such that an electrode laminate is manufactured.
The forming of the first layer is performed such that a relation in the following Expression (1)

0.1<Sa<0.2 (1)
is satisfied
where
Sa represents an arithmetic mean height of the surface of the first layer, and
Sa is in increments of μm.

The arithmetic mean height (Sa) represents three-dimensional surface roughness. When Sa becomes large, the slurry can penetrate deeply into voids of a base layer (first layer). Penetration by the slurry forces gas out of the voids. It is thought that the gas thus forced out forms bubbles in an upper layer (second layer).

According to new knowledge of the present disclosure, reduction in bubbles is anticipated due to Sa being less than 0.2 μm. Improvement in interlayer adhesion strength is anticipated due to Sa being greater than 0.1 μm.

2. In the electrode laminate manufacturing method described in “1.” above, the forming of the first layer may be performed such that a relation in the following Expression (2) is satisfied.

0.13≤Sa≤0.16 (2)

3. In the electrode laminate manufacturing method described in “1.” or “2.” above, the first layer may be, for example, an active material layer. The second layer may be, for example, a solid electrolyte layer.

4. An all-solid-state battery manufacturing method includes the following (d).
(d) forming a power generating element, including the electrode laminate manufactured by the electrode laminate manufacturing method according to any one of “1.” to “3.”.

5. An electrode laminate includes a first layer and a second layer. The second layer is laminated on the first layer. A maximum pore diameter of the first layer is 0.215 μm to 0.240 μm. A bubble density of the second layer is less than 6 bubbles/cm².

The electrode laminate described in “5.” above can be manufactured by, for example, the electrode laminate manufacturing method described in “1.” above. The maximum pore diameter reflects contact area at an interface between the first layer and the second layer. The greater the maximum pore diameter is, the greater a contact area is indicated. Improvement in interlayer adhesion strength is anticipated, due to the maximum pore diameter being 0.215 μm or greater. Reduction in bubbles is anticipated, due to the maximum pore diameter being 0.240 μm or less. Thus, bubble density of less than 6 bubbles/cm² can be realized.

6. In the electrode laminate described in “5.” above, the first layer may be, for example, an active material layer. The second layer may be, for example, a solid electrolyte layer.

7. An all-solid-state battery includes a power generating element. The power generating element includes the electrode laminate described in “5.” or “6.”.

Hereinafter, an embodiment of the present disclosure (hereinafter may be simply referred to as “present embodiment”) and examples of the present disclosure (hereinafter may be simply referred to as “examples”) will be described. The present embodiment and the examples thereof are not intended to limit the technical scope of the present disclosure.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an example of a second layer in which bubbles are generated;

FIG. 2 is a schematic flowchart of a manufacturing method according to an embodiment; and

FIG. 3 is a conceptual diagram of an electrode laminate according to the embodiment.

### DETAILED DESCRIPTION OF EMBODIMENTS

Terms, Definitions Thereof, and so Forth

The terms “comprise,” “include,” “have,” and variations thereof (e.g., “composed of” and so forth) are open-ended. When any of the open-ended terms is used, it means that additional elements may or may not be included in addition to essential elements. The term “consist of” is closed-ended. Even when a closed-ended term is used, this does not mean that additional elements such as normally accompanying impurities and elements irrelevant to the technique of the present disclosure are excluded. The term “substantially consist of” is semi-closed-ended. When a semi-closed-ended term is used, this means that it is allowed to add elements that do not substantially affect the basic and novel characteristics of the technique of the present disclosure.

The words such as “may” and “can” are used in a permissive sense, meaning that “it is possible,” rather than in a mandatory sense, meaning “must.”

Elements in a singular form can also be plural unless otherwise specified. For example, the term “particle” can mean not only “one particle” but also an “agglomerate of particles (powder, powdery material, or group of particles).”

Numerical ranges such as “m% to n%” and so forth, for example, are inclusive ranges including upper limit values and lower limit values thereof, unless otherwise specified. That is to say, “m% to n%” indicates the numerical range of “m% or more and n% or less.” Further, “m% or greater and n% or less” includes “greater than m% and less than n%.” A numerical value optionally selected from within the numerical range may be set to a new upper limit value or a new lower limit value. For example, a new numerical range may be set by optionally combining a numerical value in the numerical range and a numerical value shown in a different part of the present specification, in a table, in the drawings, etc.

All numerical values should be interpreted as being modified by the term “about”. The term “about” can mean, for example, ±5%, ±3%, ±1%, and so forth. All numerical values can be approximate values that can change depending on the way in which the technique of the present disclosure is used. All numerical values can be expressed in significant figures. A measured value can be an average of a plurality of measurements. The number of measurements may be three or more, five or more, or 10 or more. Typically, the larger the number of measurements is, the higher the reliability of the average is anticipated to be. A measured value can be rounded off based on the number of places of significant figures. A measured value can include variation or the like that is associated with, for example, the detection limit of a measuring device, or the like.

Geometric terms (e.g., “parallel,” “perpendicular,” orthogonal”, and so forth) should not be interpreted in a strict sense. For example, the term “parallel” may refer to a state deviating slightly from “parallel” in a strict sense. When any geometric term is used, it can include, for example, tolerance, variation, and so forth, in terms of design, work, manufacturing, and so forth. The dimensional relations in the drawings may not agree with the actual dimensional relations. The dimensional relations (length, width, thickness, etc.) in the drawings may have been changed in order to facilitate understanding of the technology of the present disclosure. Moreover, part of the configurations may be omitted.

The term “principal face” indicates a face having the largest area among outer faces of an object (e.g., a hexahedron).

When a compound is represented by a stoichiometric composition formula (e.g., “LiCoO₂” or the like), the stoichiometric composition formula is merely a representative example of the compound. The compound may have a non-stoichiometric composition. For example, when lithium cobalt oxide is represented by “LiCoO₂,” lithium cobalt oxide is not limited to the composition ratio of “Li:Co:O=1:1:2” and can contain lithium (Li), cobalt (Co), and oxygen (O) in any composition ratio, unless otherwise specified. Moreover, doping with a trace element, substitution with a trace element, and so forth, can be allowed.

“D50” indicates a particle diameter at which the cumulative frequency reaches 50% in a volume-based particle diameter distribution when counted from the smallest particle diameter. D50 can be measured by a laser diffraction method.

An “arithmetic mean height (Sa)” is a value defined in ISO25178. Sa is measured according to this standard. Sa can be measured by laser microscopy. For example, a laser microscope “VK-X3000” manufactured by Keyence Corporation may be used. The laser microscope may be replaced with an equivalent to “VK-X3000”.

A “maximum pore diameter” is measured by the following procedure. A pore diameter distribution of the first layer is measured by mercury porosimetry. The pore diameter distribution is fitted to a normal distribution. The maximum pore diameter can be found from the following Expression (3).

Dₘₐₓ=μ+3σ (3)
Dₘₐₓ represents the maximum pore diameter. μ represents the average value of normal distribution. σ represents the standard deviation of normal distribution.

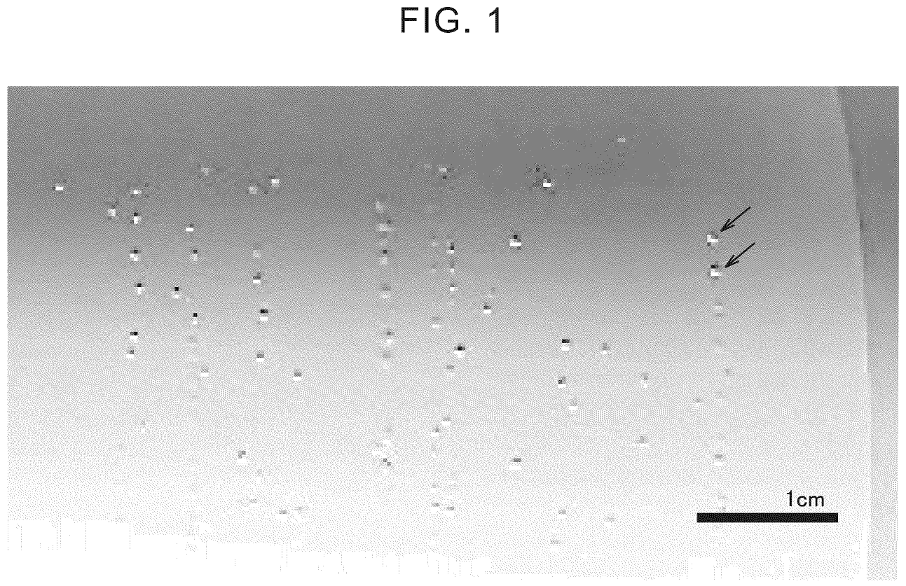

A “bubble density” is measured by the following procedure. Bubbles having a maximum Feret diameter of 30 μm or more are counted on the principal face of the second layer following pressing. The bubble density (count/cm²) is obtained by dividing the number of bubbles by the area of the principal face of the second layer. FIG. 1 is an example of the second layer in which bubbles are generated. A plurality of bubbles can be confirmed on the principal face of the second layer (upper face of the electrode laminate).

Manufacturing Method

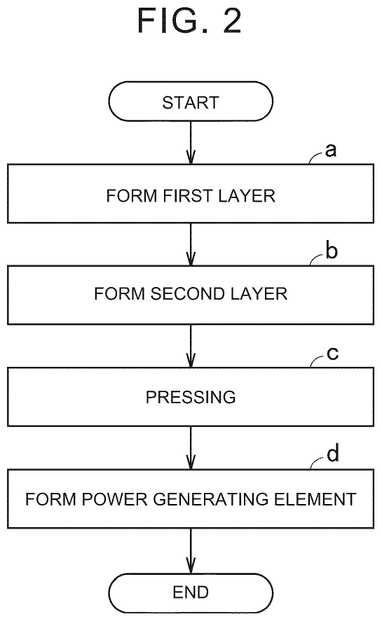

FIG. 2 is a schematic flowchart of a manufacturing method according to the present embodiment. Hereinafter, the phrase “manufacturing method according to the present embodiment” may be abbreviated to “present manufacturing method”. The present manufacturing method includes an “electrode laminate manufacturing method” and an “all-solid-state battery manufacturing method”. The electrode laminate manufacturing method includes “(a) formation of first layer”, “(b) formation of second layer”, and “(c) pressing”. The all-solid-state battery manufacturing method includes (a) to (c), and further includes “(d) forming a power generating element.”

(a) Formation of First Layer

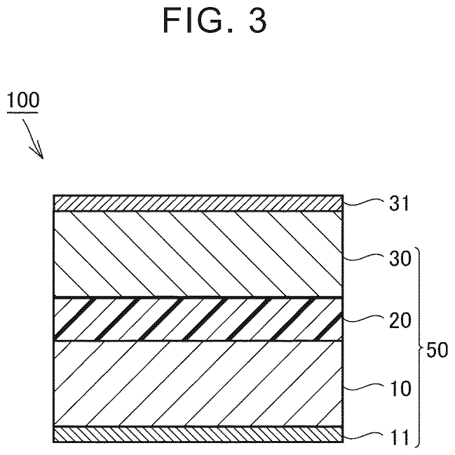

FIG. 3 is a conceptual diagram of the electrode laminate according to the present embodiment. The present manufacturing method includes forming a first layer 10. The first layer 10 can be formed by any method. The first layer 10 may be formed by, for example, coating of a first slurry.

A substrate 11 may be provided, for example. The substrate 11 may be in a form of a sheet, for example. The substrate 11 may have a thickness of 5 μm to 50 μm, for example. The substrate 11 may have electroconductivity, for example. The substrate 11 may function as a current collector. The substrate 11 may include a metal foil, for example. The substrate 11 may contain, for example, at least one type selected from a group consisting of aluminum (Al), nickel (Ni), chromium (Cr), copper (Cu), and iron (Fe).

The first slurry may be prepared by mixing an active material, an electroconductive material, a solid electrolyte, a binder and a dispersion medium, for example. Any mixer can be used in the present manufacturing method. The first slurry is coated onto a surface of the substrate 11. The first layer 10 can be formed by drying the first slurry. That is to say, the first layer 10 may be an active material layer. Any coater and dryer can be used in the present manufacturing method.

After forming the first layer 10 (after drying the first slurry), the first layer 10 may be subjected to pressing. A rolling press machine, for example, may be used. The first layer 10 can be optional. The first layer 10 may have a thickness of, for example, 10 μm to 200 μm after pressing.

Three-Dimensional Surface Height (Sa)

In the present manufacturing method, the first layer 10 can be formed to have an Sa of greater than 0.1 μm and less than 0.2 μm. According to this, improved interlayer adhesion strength and reduction in bubbles can be anticipated. The Sa may be 0.13 μm or more, or may be 0.14 μm or more, for example. The Sa may be 0.16 μm or less, or may be 0.14 μm or less, for example.

The Sa can be adjusted by any method. For example, the Sa may be adjusted by particle size distribution and so forth of the constituent material of the first layer 10. The Sa may be adjusted by roll linear pressure or the like during pressing, for example. The roll linear pressure may be, for example, 0.2 t/cm or more, or may be 0.25 t/cm or more. The roll linear pressure may be, for example, 0.3 t/cm or less, or may be 0.25 t/cm or less.

Active Material

The active material is particulate. The active material may have a D50 of 1 μm to 30 μm, for example. The active material may be, for example, a cathode active material. The cathode active material may contain, for example, at least one type selected from a group consisting of graphite, Si, SiOₓ(0<x<2), and Li₄Ti₅O₁₂.

The active material may be, for example, an anode active material. The anode active material may contain, for example, at least one type selected from a group consisting of LiCoO₂, LiNiO₂, LiMnO₂, LiMn₂O₄, Li(NiCoMn)O₂, Li(NiCoAl)O₂, and LiFePO₄. Note that “(NiCoMn)” in “Li(NiCoMn)O₂”, for example, indicates that the sum of the elements inside the parentheses is 1 in terms of composition ratio. The amounts of the individual components are optional as long as the sum is 1. Li(NiCoMn)O₂ may include, for example, LiNi_{1/3}Co_{1/3}Mn_{1/3}O₂, LiNi_{0.5}Co_{0.2}Mn_{0.3}O₂, LiNi_{0.8}Co_{0.1}Mn_{0.1}O₂, and so forth. Li(NiCoAl)O₂ may include, for example, LiNi_{0.8}Co_{0.15}Al_{0.05}O₂, and so forth.

Electroconductive Material

The electroconductive material can form an electron-conductive path. The amount of the electroconductive material that is contained may be, for example, 0.1 to 10 parts by mass, with respect to 100 parts by mass of the active material. The electroconductive material can contain any component. The electroconductive material may contain, for example, at least one type selected from a group consisting of carbon black (CB), vapor-grown carbon fibers (VGCF), carbon nanotubes (CNTs), and graphene flakes (GF).

Solid Electrolyte

The solid electrolyte can form an ion-conductive path. The solid electrolyte is particulate. The solid electrolyte may have a D50 of 0.5 μm to 5 μm, for example. The amount of the solid electrolyte that is contained may be, for example, 1 part by volume to 200 parts by volume with respect to 100 parts by volume of the active material. The solid electrolyte may contain, for example, at least one selected from a group consisting of sulfides, oxides and hydrides. The solid electrolyte may contain, for example, at least one selected from a group consisting of LiI—LiBr—Li₃PS₄, Li₂S—SiS₂, LiI—Li₂S—SiS₂, LiI—Li₂S—P₂S₅, LiI—Li₂O—Li₂S—P₂S₅, LiI—Li₂S—P₂O₅, LiI—Li₃PO₄—P₂S₅, Li₂S—P₂S₅, and Li₃PS₄.

“LiI—LiBr—Li₃PS₄”, for example, represents a solid electrolyte formed by mixing LiI, LiBr, and Li₃PS₄, at any molar ratio. The solid electrolyte may be produced by a mechanochemical method, for example. “Li₂S—P₂S₅” includes Li₃PS₄. Li₃PS₄ can be produced by, for example, mixing Li₂S and P₂S₅ in a molar ratio of “Li₂S:P₂S₅=75:25”. The solid electrolyte may be, for example, a glass-ceramic type or an argyrodite type.

Binder

A binder can bind the solid materials together. The amount of the binder that is contained may be, for example, 0.1 to 10 parts by mass, with respect to 100 parts by mass of the active material. The binder can contain any component. The binder may contain, for example, at least one type selected from a group consisting of polyvinylidene difluoride (PVDF), a polyvinylidene difluoride-hexafluoropropylene copolymer (PVDF-HFP), styrene butadiene rubber (SBR), butadiene rubber (BR), and polytetrafluoroethylene (PTFE).

Dispersion Medium

The dispersion medium is a liquid. The dispersion medium may contain, for example, water, an organic solvent, or the like. The dispersion medium may contain, for example, water, N-methyl-2-pyrrolidone, butyl butyrate, and so forth.

(b) Formation of Second Layer

The present manufacturing method includes forming a second layer 20 by coating a second slurry onto a surface of the first layer 10.

The second slurry may be prepared by mixing a solid electrolyte, a binder, and a dispersion medium, for example. Details of the solid electrolyte and so forth are as described above. The solid electrolyte, the binder, and the dispersion medium may be the same type or different types among the first layer 10 and the second layer 20.

The second slurry is coated onto the surface of the first layer 10. The second layer 20 is formed by drying the second slurry. That is to say, the second layer 20 may be a solid electrolyte layer. A solid electrolyte layer can function as a separator in an all-solid-state battery.

In the present manufacturing method, the Sa of the first layer 10 is greater than 0.1 μm and less than 0.2 μm, and accordingly it is anticipated that the second slurry will appropriately seep into the surface of the first layer 10. Thus, improved interlayer adhesion strength and reduction in bubbles can be anticipated.

(c) Pressing

The present manufacturing method includes manufacturing an electrode laminate 50 by subjecting the second layer 20 to pressing. A rolling press machine, for example, may be used. The roll linear pressure when pressing the second layer 20 may be lower than when pressing the first layer 10. The roll linear pressure may be, for example, 0.2 t/cm or less, or may be 0.1 t/cm or less. The roll linear pressure may be, for example, 0.01 t/cm or more.

The thickness of the second layer 20 can be optional. The second layer 20 after pressing may be thinner than the first layer 10, for example. The second layer 20 may have a thickness of, for example, 5 μm to 50 μm after pressing.

(d) Forming a Power Generating Element

The present manufacturing method may include forming a power generating element 100 that includes the electrode laminate 50. For example, a third layer 30 may be formed by coating a third slurry onto a surface of the second layer 20. The third layer 30 may be, for example, an active material layer. Third layer 30 may have a different polarity from the first layer 10. For example, the first layer 10 may be a cathode active material layer, and the third layer 30 may be an anode active material layer. For example, the first layer 10 may be an anode active material layer, and the third layer 30 may be a cathode active material layer.

The surface of the second layer 20 may also have an Sa that is greater than 0.1 μm and less than 0.2 μm, for example. Thus, an improvement in interlayer adhesion strength and a reduction in bubbles between the second layer 20 and the third layer 30 are anticipated.

The number of layers of the electrode laminate 50 is optional. For example, a fourth layer, a fifth layer (omitted from illustration), and so on, may be further laminated on the third layer 30. Even after the third layer 30 is formed, the surface of each layer may be formed to have an Sa that is greater than 0.1 μm and less than 0.2 μm.

The power generating element 100 may further include a current collector 31. The current collector 31 may contain, for example, metal foil or the like, in the same way as with the substrate 11. The current collector 31 may be applied to the outermost layer by an adhesive, for example. Furthermore, an external terminal (omitted from illustration) may be connected to the current collector 31 and the substrate 11.

The power generating element 100 may be housed in an encasement (omitted from illustration). The encasement can have any form. The encasement may be, for example, a metal case or the like. The encasement may be, for example, a pouch made of a metal foil laminated film, or the like. Thus, an all-solid-state battery can be manufactured.

In the present manufacturing method, an example is described regarding a form in which the first layer 10 is an active material layer and the second layer 20 is a solid electrolyte layer. That is to say, the combination of the first layer 10 and the second layer 20 is optional. For example, the first layer 10 may be a solid electrolyte layer and the second layer 20 may be an active material layer.

All-Solid-State Battery

The all-solid-state battery includes the power generating element 100 (see FIG. 3). The all-solid-state battery may include one power generating element 100 alone, or may include two or more power generating elements. A plurality of the power generating elements 100 may form a parallel circuit or may form a series circuit.

The power generating element 100 may be housed in an encasement (omitted from illustration). The power generating element 100 includes the electrode laminate 50. The power generating element 100 may further include the current collector 31, and so forth. The electrode laminate 50 includes the first layer 10 and the second layer 20. The second layer 20 is laminated on the first layer 10. The electrode laminate 50 may further include the substrate 11, the third layer 30, and so forth.

The first layer 10 has a maximum pore diameter of 0.215 μm to 0.240 μm. The second layer 20 has a bubble density of less than 6 bubbles/cm². The bubble density may be, for example, 3 bubbles/cm² or less, or may be 1 bubble/cm² or less, or may be 0 bubbles/cm². The lower the bubble density is, the higher battery performance (i.e., output characteristics, etc.) can be anticipated to be.

Preparation of Samples

Electrode laminates were respectively manufactured according to Manufacturing Examples 1 to 5 below.

Manufacturing Example 1

A first slurry was prepared by mixing a cathode active material (Li₄Ti₅O₁₂, D50=1.1 μm), an electroconductive material, a solid electrolyte, a binder, and a dispersion medium.

The first layer was formed by performing coating of the first slurry onto the surface of a substrate (Al foil), and drying thereof. The first layer was subjected to pressing by a rolling press machine. Roll linear pressure was 0.1 t/cm. After pressing, the first layer had a thickness of 100 μm. The Sa and the maximum pore diameter of the first layer after pressing were measured.

A second slurry was prepared by mixing a solid electrolyte (Li₃PS₄, D50=2.2 μm), a binder, and a dispersion medium. The second layer was formed by performing coating of the second slurry onto the surface of the first layer, and drying thereof. The second layer was subjected to pressing by a rolling press machine. Roll linear pressure was 0.1 t/cm. After pressing, confirmation was made regarding whether interlayer delamination had occurred. Further, the bubble density of the second layer was measured. Thus, an electrode laminate was manufactured.

Manufacturing Examples 2 to 5

As shown in Table 1 below, an electrode laminate was manufactured in the same way as in Manufacturing Example 1, except that the roll linear pressure during pressing of the first layer was changed.

TABLE 1
Table 1

| | First layer | | | | |
|---|---|---|---|---|---|
| | Roll | | Maximum | Electrode laminate | |
| Manu- | linear | | pore | | Bubble |
| facturing | pressure | Sa | diameter | Interlayer | density |
| Example | (t/cm) | (μm) | (μm) | delamination | (bubbles/cm²) |
| 1 | 0.1 | 0.2 | 0.271 | None | 6 |
| 2 | 0.2 | 0.16 | 0.240 | None | 0 |
| 3 | 0.25 | 0.14 | — | None | 0 |
| 4 | 0.3 | 0.13 | 0.215 | None | 0 |
| 5 | 0.4 | 0.1 | 0.187 | Observed | 0 |

Results

As shown in Table 1 above, when the Sa of the first layer is greater than 0.1 μm, there is a tendency that interlayer delamination is less likely to occur. When the Sa of the first layer is less than 0.2 μm, the bubble density tends to decrease.

The present embodiment and the examples thereof are exemplary in all respects. The present embodiment and the examples thereof are not restrictive. The technical scope of the present disclosure includes all modifications that fall within the meaning and scope equivalent to the claims. For example, it is planned from the beginning to extract optional configurations from the present embodiment and the examples thereof, and to optionally combine the extracted configurations.

What is claimed is:

1. An electrode laminate manufacturing method comprising:
(a) forming a first layer;
(b) forming a second layer by coating a slurry onto a surface of the first layer; and
(c) subjecting the second layer to pressing such that an electrode laminate is manufactured, wherein the forming of the first layer is performed such that a relation in the following Expression (1)
0.1<Sa<0.2 (1)
is satisfied
where
Sa represents an arithmetic mean height of the surface of the first layer, and
Sa is in increments of μm.

2. The electrode laminate manufacturing method according to claim 1, wherein the forming of the first layer is performed such that a relation in the following Expression (2) is satisfied.
0.13≤Sa≤0.16 (2)

3. The electrode laminate manufacturing method according to claim 1, wherein:
the first layer is an active material layer; and
the second layer is a solid electrolyte layer.

4. An all-solid-state battery manufacturing method, comprising (d) forming a power generating element, including the electrode laminate manufactured by the electrode laminate manufacturing method according to claim 1.

5. An electrode laminate comprising:
a first layer; and
a second layer, wherein:
the second layer is laminated on the first layer;
a maximum pore diameter of the first layer is 0.215 μm to 0.240 μm; and
a bubble density of the second layer is less than 6 bubbles/cm².

6. The electrode laminate according to claim 5, wherein:
the first layer is an active material layer; and
the second layer is a solid electrolyte layer.

7. An all-solid-state battery comprising a power generating element, wherein the power generating element includes the electrode laminate according to claim 5.
